(19) United States
(12) Patent Application Publication
(10) Pub. No.: US 2009/0000681 A1
(43) Pub. Date: Jan. 1, 2009

(54) REINFORCED DOUBLE-WALLED PIPE AND MANUFACTURING METHOD

(76) Inventors: Daniel Averbuch, Vernaison (FR); Mickael Martinez, Lyon (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/147,711

(22) Filed: Jun. 27, 2008

(30) Foreign Application Priority Data
Jun. 29, 2007 (FR) 07/04.706

(51) Int. Cl. F16L 9/18; B23P 15/26

(52) U.S. Cl. 138/112; 29/890.036; 138/148; 138/114

(57) ABSTRACT

The double-walled pipe comprises a rigid internal tube 2 arranged in a rigid external tube 3, the tubes being separated by an annular space, centering elements holding the internal tube in position in relation to the external tube.

External tube 3 withstands alone an external pressure at least above 50 bars.

The mechanical resistance of the pipe to the external pressure is reinforced by placing centering elements 4 in contact with internal tube 2 and with external tube 3.

### FIELD OF THE INVENTION

The present invention relates to the field of double-walled pipes for fluid transportation.

### BACKGROUND OF THE INVENTION

A double-walled pipe, commonly referred to as pipe-in-pipe, consists of two respectively internal and external coaxial metallic tubes, separated by an annular space filled with an insulating material. The internal tube is held in position in relation to the external tube by centering elements commonly referred to as spacers. Spacers generally have the shape of rings.

Double-walled pipes are notably used in the petroleum industry for carrying oil from a wellhead at the sea bottom to a surface processing plant. The pipes installed at the sea bottom, commonly referred to as flowlines, mainly undergo static mechanical stresses; on the other hand, the pipes connecting the sea bottom to the surface, commonly referred to as risers, undergo static and dynamic mechanical stresses.

Offshore reservoir development is performed up to water depths that currently reach 1500 m and more. Future developments are considered for depths reaching 3000 m and more. It is therefore important to have pipes of high mechanical strength.

Double-walled pipes are mainly used for their good thermal insulation characteristic to convey hot petroleum products in a marine environment at great depth. Too great cooling of these petroleum products would be problematic under normal production conditions and in the case of production stop. Cooling of the transported petroleum effluent can in fact cause viscosity increase, paraffin precipitation and asphaltenes flocculation that increase the viscosity of the effluent and lead to deposits that reduce the useful internal diameter of the pipe, or to the formation of gas hydrates that may clog the pipe.

Document FR-2,815,693 describes an embodiment of a double-walled pipe wherein the internal tube is not connected to the external tube.

However, the use of pipe-in-pipe type lines is penalized by the own weight of these pipes. Currently, pipe-in-pipe lines are among the heaviest pipes laid on the sea bed. This is explained by the fact that the internal tube must withstand alone the pressure of the fluid circulating in the pipe and the external tube must withstand alone the hydrostatic external pressure.

The present invention aims to reduce the weight of pipe-in-pipe type lines. The invention describes a double-walled pipe wherein centering elements reinforce the mechanical resistance of the external tube.

### SUMMARY OF THE INVENTION

In general terms, the invention describes a reinforced double-walled pipe comprising a rigid internal tube arranged in a rigid external tube, the tubes being separated by an annular space, centering elements holding the internal tube in position in relation to the external tube. According to the invention, said external tube withstands alone an external pressure at least above 50 bars and the centering elements are in contact with the internal tube and the external tube so as to reinforce the mechanical resistance of the external tube to the external pressure.

According to the invention, the centering elements can consist of a material having a Young's modulus above 1000 MPa at 20° C. The centering elements can consist of a material having a thermal conductivity below 1 W.m⁻¹.K⁻¹ at a temperature ranging between 0° C. and 150° C.

The centering elements can comprise rings arranged in the annular space at intervals ranging between 1 and 5 times the external diameter of the external tube.

Alternatively, the centering elements can comprise a strip helically wound in the annular space.

Alternatively, the centering elements can comprise studs.

The annular space can be filled with an insulating material having a thermal conductivity below 0.1 W.m⁻¹.K⁻¹. Alternatively, the annular space can be placed under vacuum at a pressure below 0.1 bar abs.

The invention also describes a method of manufacturing a reinforced double-walled pipe, said pipe comprising a rigid internal tube arranged in a rigid external tube, the tubes being separated by an annular space, centering elements holding the internal tube in position in relation to the external tube. According to the invention, the rigid external tube is selected in such a way that said external tube withstands an external pressure above 50 bars and the centering elements are placed in contact with the internal tube and the external tube so as to increase the mechanical resistance of the external tube to the external pressure.

According to the invention, the centering elements can be arranged around the internal tube, the internal tube provided with the centering elements can be fed into the external tube and one of the two tubes can be permanently deformed so as to bring the centering elements into contact with the internal tube and the external tube.

Alternatively, the internal tube can be fed into the external tube and a material can be injected into the annular space so as to form centering elements in contact with the internal tube and the external tube.

Alternatively, the centering elements can be arranged around the internal tube, the internal tube provided with the centering elements can be fed into the external tube and mechanical tightening of the centering elements against the internal tube and the external tube can be performed.

An insulating material having a thermal conductivity below 0.1 W.m⁻¹.K⁻¹ can be arranged in the annular space. Alternatively, the annular space can be placed under vacuum at a pressure below 0.1 bar abs.

The pipe according to the invention has a higher mechanical resistance allowing to reduce the steel thicknesses used and therefore to lighten the pipe. Thus, the pipe according to the invention can be used for the development of reservoirs located at great water depths.

### BRIEF DESCRIPTION OF THE FIGURES

Other features and advantages of the invention will be clear from reading the description hereafter, with reference to the accompanying figures wherein:

FIG. 1 is a longitudinal sectional view of a double-walled pipe portion,

FIGS. 1A and 1B diagrammatically illustrate the buckling of a tube,

FIGS. 2A, 2B, 2C and 2D diagrammatically show various centering elements,

FIGS. 3A, 3B, 3C, 3D, 4A, 4B, 5A, 5B, 5C and 6A, 6B, 6C, 6D diagrammatically show various stages of the manufacture of a double-walled pipe according to the invention,

FIG. 7 shows an evolution curve of the collapse pressure for a pipe-in-pipe type line as a function of the play between the centering elements and the tubes.

### DETAILED DESCRIPTION

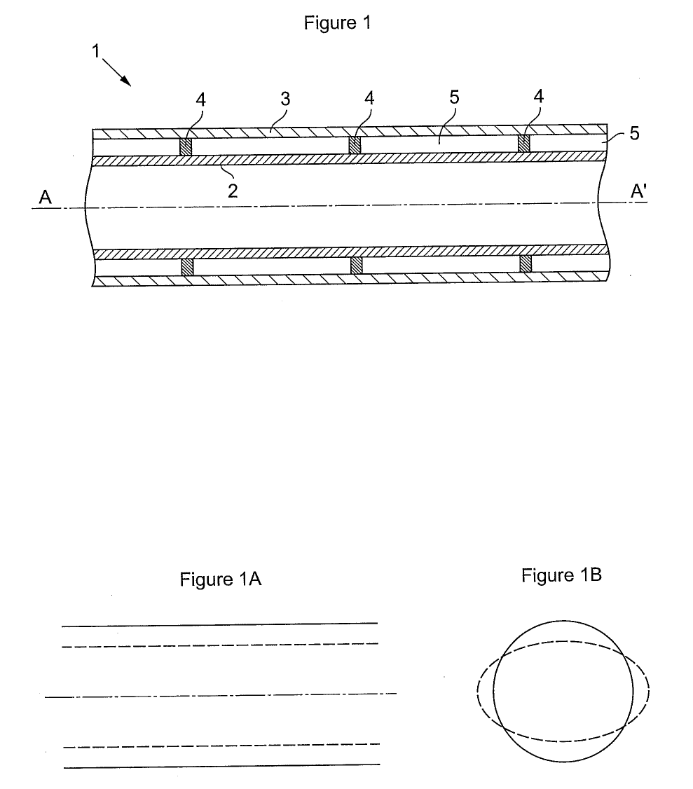

Double-walled pipe 1 of longitudinal axis AA′, partially shown in FIG. 1, comprises an internal wall or tube 2 commonly referred to as flowline and an external wall or tube 3 commonly referred to as carrier pipe. Internal tube 2 wherein the fluid to be transported circulates provides internal pressure strength and sealing against the fluid transported, a petroleum effluent for example. External tube 3 provides external pressure strength and sealing against the medium external to pipe 1, the sea water for example.

In general, tubes 2 and 3 are made of a metallic material, steel, aluminium or titanium for example. The invention can also be implemented with tubes 2 and 3 made of a composite material with a matrix made of a thermoplastic or thermosetting organic material, reinforced with carbon, glass or other fibers.

Internal tube 2 is positioned in relation to external tube 3 by means of centering elements or radial stops 4 so as to be substantially coaxial. Centering elements 4 are evenly arranged in the annular space between tubes 2 and 3 along pipe 1.

The annular space between centering elements 4 is filled with elements 5 made of an insulating material subjected to no notable mechanical loading. An insulating material whose thermal conductivity is below 0.1 W.m⁻¹.K⁻¹ is generally selected. Foams, aerogels or gels can be used. The insulating material can be positioned by winding thick strips around internal tube 2.

Alternatively to the use of the insulating material, the annular space can be placed under vacuum, for example at a pressure below 0.1 bar abs., in order to limit heat exchanges between tubes 2 and 3.

Manufacturing rules for pipes intended to convey a petroleum effluent in a marine environment are notably given by documents API 1111 ed. 1999 and DNV-OS-F101. According to the invention, the purpose of centering elements 4 is to reinforce the mechanical strength of the external tube.

Ruin of a pipe-in-pipe type line subjected to an external pressure occurs through buckling of the external tube. Buckling of a rigid tube, i.e. withstanding an external pressure at least above 50 bars, under an external pressure, can occur in the longitudinal direction of the tube and along the section of the tube. In FIGS. 1A and 1B, the full lines represent the tube before buckling, the dotted lines represent the tube deformed by buckling. Buckling in the longitudinal direction corresponds to a uniform shift of the generatrices of the tube as shown in FIG. 1A. Buckling along the section corresponds to an ovalization of the tube as shown in FIG. 1B.

According to the invention, localized reinforcement pieces are arranged on the inner surface of the external tube in order to perturb the natural buckling modes of external tube 3. Tube 3 is reinforced by means of centering elements 4. According to the invention, centering elements 4 are in contact with the inner surface of external tube 3 and they locally reinforce the mechanical strength of the external tube in order to increase the mechanical resistance of the tube to the external pressure. It is thus possible to increase the mechanical resistance of the pipe, or to decrease the requirements as regards the material or the dimensions of the internal and external tubes. This allows to reduce the steel thicknesses of the tubes and therefore to lighten the pipe-in-pipe type lines.

According to the invention, there is no play between internal tube 2, a centering element 4 and external tube 3. The absence of play between the centering elements and the two tubes allows to transmit the strains between the internal tube and the external tube. The two walls are mechanically linked and they cooperate to withstand mechanical loadings together. In particular, the radial strains applied on the outer surface of pipe 1 can be distributed among the external tube and the internal tube.

Centering elements 4 can be secured to tubes 3 and/or 2, i.e. a mechanical link connects centering elements 4 to tube 3 and/or tube 2. Centering elements 4 can also be simply in contact with tubes 3 and/or 2 without being fastened thereto.

In order to be able to perturb the buckling mode at any point of the external tube, elements 4 must provide reinforcing zones evenly distributed along the pipe. In the case of ring-shaped centering elements, such elements can be arranged in the annular space at intervals ranging between 1 and 5 times the external diameter of the external tube, along the pipe.

It has been shown by means of numerical calculations that the load taken up by centering elements 4 is relatively low in relation to the load undergone by the external tube subjected to an external pressure. In fact, taking up of a small part of the strains generated by the external pressure by elements 4 perturbs sufficiently the buckling modes and therefore increases the external pressure resistance. Elements 4 can take up 1% to 10% of the strains generated by the external pressure exerted on tube 3. According to the invention, centering elements of low mechanical strength in relation to the mechanical strength of the external pipe can be used.

The characteristics of the centering elements can thus be selected so as to optimize the mechanical strength of the double-walled pipe while maintaining a good thermal insulation. In fact, the centering elements according to the invention, because they are in contact with the internal tube and the external tube, form “thermal bridges”, i.e. a preferred crossing point for the heat flows between the internal tube and the external tube. In order to obtain the best mechanical characteristics for pipe 1 according to the invention, a maximum amount of the most resistant centering elements possible is used. On the other hand, to limit heat exchanges between the inside and the outside of pipe 1, the number of centering elements is limited, and the least heat-conducting materials and dimensions possible are selected. The material, the dimensions and the spacing of the centering elements are selected so as to limit heat exchanges between tubes 2 and 3, while maintaining the strain distributor function between these tubes 2 and 3.

Materials having good mechanical properties, preferably with a Young's modulus above 1000 MPa at 20° C., or even 2000 MPa at 20° C., and suitable thermal properties, are selected for centering elements 4 in contact with the internal tube and the external tube. The thermal conductivity of the material can be below 1 W.m⁻¹.K⁻¹, preferably below 0.5 W.m⁻¹.K⁻¹ or 0.3 W.m⁻¹.K⁻¹, at the operating temperature of the pipe, i.e. in the range between 0° C. and 150° C. For example, the centering elements are made of glass fiber mat composite material, i.e. short fibers having any orientation, in a matrix made of epoxy resin, polyurethane or polypropylene. It is also possible to use a syntactic foam comprising glass microspheres in an epoxy matrix. These two materials delimit, in terms of Young's modulus and of thermal conductivity, the range of materials that are suitable for making the centering elements according to the invention. In general terms, the following materials can be selected: concrete, polymer or elastomer plastic materials (epoxy, polyurethane, polypropylene polyamine, polyethylene, . . . ) and composite materials.

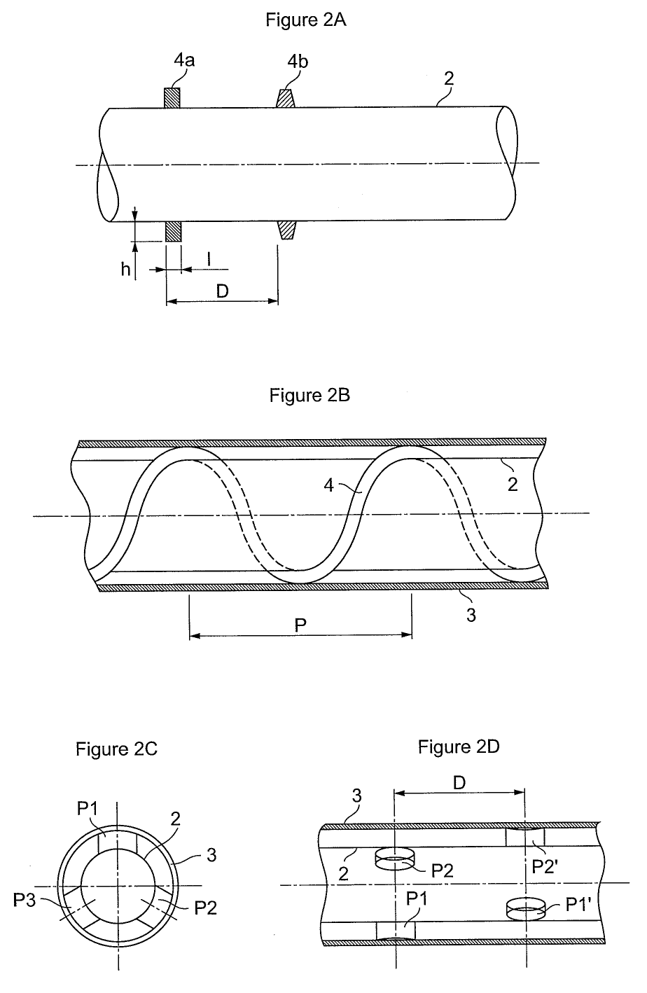

FIG. 2A shows an internal tube 3 provided with ring-shaped centering elements. In general, each element 4 consists of two half rings. The half rings are assembled around internal tube 2 for example by screwing one half ring onto the other. Centering element 4a is a ring of rectangular section, of width l and height h. Centering element 4b is a ring of trapezoid-shaped section, the largest base of the trapezoid being in contact with internal tube 2. The centering elements are separated by a distance D.

With reference to FIG. 2B, centering element 4 consists of a strip wound around tube 2 in a helix of pitch p. The upper part of the strip is in contact with the inner wall of tube 3.

The centering elements can be given the shape of studs that are distributed along the pipe. FIGS. 2C and 2D illustrate centering elements in form of studs P1, P2 and P3 of cylindrical shape. They can also have other shapes, for example rectangular, elliptical, or any shape. These studs can be arranged with axes oriented along three radii, of tube 3, evenly distributed at 120° relative to one another. The base of the cylindrical studs rests on the outer surface of tube. The studs extend along radial directions of tubes 2 and 3 so as to be in contact with the inner surface of tube 3. With reference to FIG. 2D, studs P1, P2 and P3 are substantially arranged in a plane perpendicular to the axis of the pipe. Several series of three studs can be positioned at regular intervals. In FIG. 2D, the three studs P1′, P2′ and P3′ are arranged in a plane located at a distance D from the plane in which studs P1, P2 and P3 are arranged. In order to improve the reinforcing effect provided by the studs, the series of studs P1′, P2′ and P3′ can be arranged with an angular offset, of 60° for example, in relation to the axes of studs P1, P2 and P3.

The pipe fitted with two cooperating walls according to the invention can be manufactured in different ways.

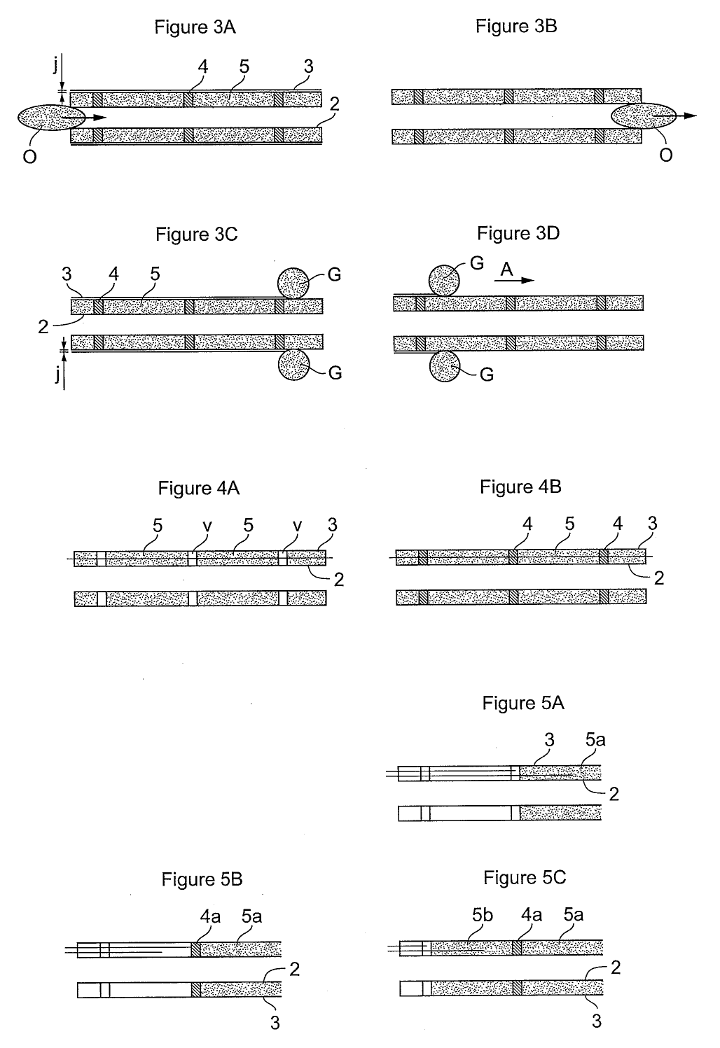

According to a first manufacturing mode described with reference to FIGS. 3A and 3B, the pipe is made by mechanical expansion of the internal tube.
Centering elements 4 and insulating material elements 5 are fastened onto internal tube 2.
The assembly consisting of internal tube 2, centering elements 4 and insulating material elements 5 is slipped into an external tube 3 whose internal diameter is greater than the diameter of the tube made up of the outer surface of the centering elements and the insulating material elements. With reference to FIG. 3A, there is a play j between centering element 4 and the inner wall of external tube 3.
With reference to FIG. 3A, a tool O is fed into internal tube 2. Tool O, an olive for example, has a revolution shape of larger diameter than the internal diameter of tube 2.
With reference to FIG. 3B, the tool is forced to travel the length of the tube so as to deform tube 2 to a larger diameter than its initial diameter. Expansion of the internal tube allows to displace centering element 4 in order to remove play j between centering elements 4 and external tube 3.

Alternatively to the first embodiment, the pipe can be manufactured by mechanical reduction of the external tube diameter by carrying out the following operations described with reference to FIGS. 3C and 3D:
Centering elements 4 and insulating material elements 5 are fastened onto internal tube 2.
The assembly consisting of internal tube 2, centering elements 4 and insulating material elements 5 is slipped into an external tube 3 whose internal diameter is larger than the diameter of the tube made up of the outer surface of the centering elements and the insulating material elements. With reference to FIG. 3C, there is a play j between centering element 4 and the inner wall of external tube 3.
With reference to FIG. 3C, the assembly consisting of tubes 2 and 3 provided with the centering and insulating material elements is fed into a passage calibrated by rollers G. The passage has the shape of a disk whose radius is smaller than the outer radius of tube 3.
With reference to FIG. 3D, the rotation of rollers G drives the pipe in the direction shown by arrow A. Thus, by passing through the passage delimited by rollers G, tube 3 is deformed to the point where it comes into contact with centering elements 4. Play j between centering elements 4 and external tube 3 is removed.

According to a second manufacturing mode described with reference to FIGS. 4A and 4B, the pipe is made by casting centering elements 4.
Insulating material elements 5 are fastened onto internal tube 2 while leaving empty spaces V between two successive elements 5. These spaces V are intended to receive centering elements 4.
The assembly consisting of internal tube 2 fitted with insulating material elements 5 is fed into external tube 3 so as to obtain a pipe as diagrammatically shown in FIG. 4A.
Empty spaces V are filled by material injection so as to obtain centering elements 4 that are in contact with internal tube 2 and external tube 3 as shown in figure 4B. The material injected in liquid or pasty form into empty spaces V hardens and forms centering elements 4.

Alternatively, centering elements 4 can also be cast by carrying out the following stages described with reference to FIGS. 5A, 5B and 5C:
Internal tube 2 is fed into external tube 3. With reference to FIG. 5A, a first insulating material element 5a is injected into the annular space between the two tubes.
With reference to FIG. 5B, a first centering element 4a is injected after first insulating material element 5a.
With reference to FIG. 5C, a second insulating material element 5b is injected after first centering element 4a, and so on until a pipe according to the invention is obtained.

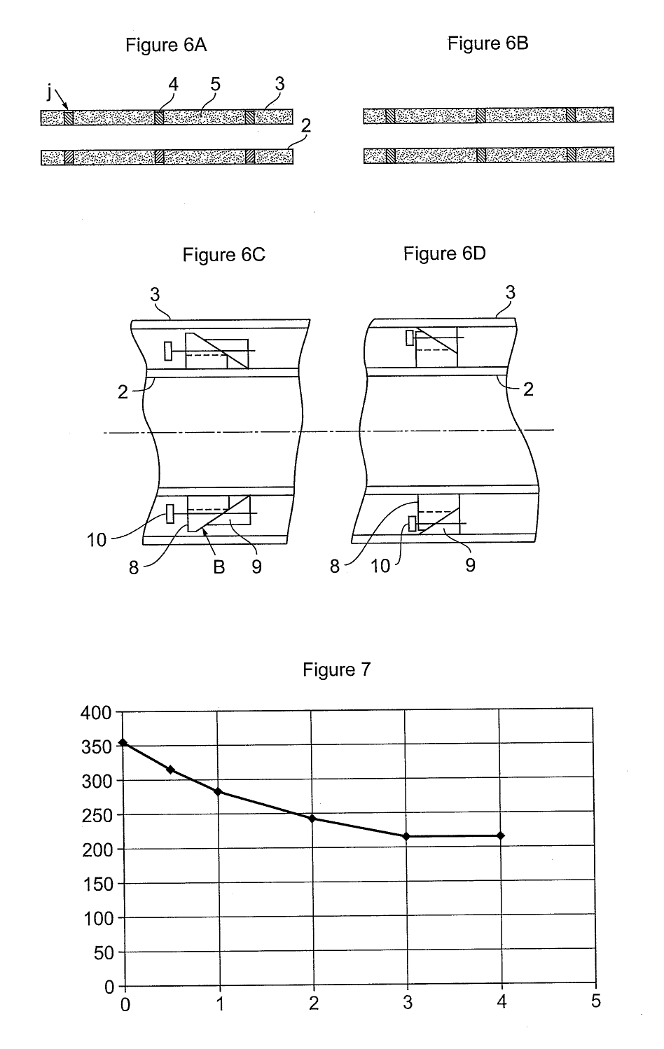

According to a third manufacturing mode described with reference to FIGS. 6a, 6B, 6C and 6D, the pipe is made by mechanical clamping of centering elements 4.
Internal tube 2 is fed into external tube 3.
A first insulating material element 5 is fed into the annular space defined between the two tubes.
A first centering element 4 is fed after first insulating material element 5. Centering element 4 is mounted in the annular space with a play j as shown in FIG. 6A: the internal diameter of centering element 4 is larger than the external diameter of internal tube 2 and/or the external diameter of element 4 is smaller than the internal diameter of external tube 3.
First centering element 4 is clamped onto the outer wall of the internal tube and onto the inner wall of the external tube so as to obtain a pipe according to FIG. 6B.

For example, clamping can be performed according to the mechanism shown in FIG. 6C. The mechanism comprises a first conical ring 8 that rests on the outer surface of internal tube 2, a second conical ring 9 resting on surface B of ring 8. Screw 10 freely runs through ring 8 and it is screwed in a thread provided in ring 9. Screw 10 forms a screw/nut system with piece 9. Rotation of screw 10 allows ring 9 to slide upon contact with ring 8 on conical surface B. Screwing is continued until ring 9 bears on the inner surface of tube 3. Alternatively, screw 8 can be replaced by a rivet.

The numerical example below allows to illustrate the advantage of a zero play between the centering elements and the external tube of a pipe-in-pipe type line.

The collapse pressure resistance of a double-walled pipe subjected to an external pressure has been studied. The pipe is made up of an internal tube separated from an external tube by centering elements made of syntactic foam.

The external diameter of the internal tube is 10″ (273.1 mm). The external diameter of the external tube is 13.73″ (348.7 mm). These tubes are made of steel: X65. The syntactic foam that consists of an epoxy matrix comprising glass microspheres has a Young's modulus of 3000 MPa at 20° C. and of 1000 MPa at 130° C.

The rings are 0.04 m in width and they are distributed at regular intervals of 0.9 m. The ring-shaped centering elements of rectangular section are in contact with the internal tube. On the other hand, there is a play between the centering elements and the external tube.

The collapse pressure of the pipe was determined by means of numerical calculations for different values of the play separating the centering element from the external tube. FIG. 7 shows the collapse pressure curve of the pipe as a function of the play between the centering element and the external tube. The play is represented by the abscissa axis in millimeter. The collapse pressure is given by the ordinate axis in bar.

It can be observed that the pipe has the best collapse resistance when the play between the centering element and the external tube is zero. A 3-mm play is sufficient to deprive the centering element of any mechanical part in the collapse strength. A 1-mm play reduces by half the collapse pressure gain provided by the centering element.

The pipe according to the invention, which aims to transmit strains between the tubes through the centering elements, therefore has the advantage of being mechanically more resistant to collapse.

1) A reinforced double-walled pipe comprising a rigid internal tube arranged in a rigid external tube, the tubes being separated by an annular space, centering elements holding the internal tube in position in relation to the external tube, characterized in that said external tube withstands alone an external pressure at least above 50 bars and in that the centering elements are in contact with the internal tube and the external tube so as to reinforce the mechanical resistance of the external tube to the external pressure.

2) A pipe as claimed in claim 1, wherein the centering elements consist of a material having a Young's modulus above 1000 MPa at 20° C.

3) A pipe as claimed in claim 1, wherein the centering elements consist of a material having a thermal conductivity below 1 W.m⁻¹.K⁻¹ at a temperature ranging between 0° C. and 150° C.

4) A pipe as claimed in claim 1, wherein the centering elements comprise rings arranged in the annular space at intervals ranging between 1 and 5 times the external diameter of the external tube.

5) A pipe as claimed in claim 1, wherein the centering elements comprise a strip helically wound in the annular space.

6) A pipe as claimed in claim 1, wherein the centering elements comprise studs.

7) A pipe as claimed in claim 1, wherein the annular space is filled with an insulating material having a thermal conductivity below 0.1 W.m⁻¹.K⁻¹.

8) A pipe as claimed in claim 1, wherein the annular space is placed under vacuum at a pressure below 0.1 bar abs.

9) A method of manufacturing a reinforced double-walled pipe, said pipe comprising a rigid internal tube arranged in a rigid external tube, the tubes being separated by an annular space, centering elements holding the internal tube in position in relation to the external tube, the method being characterized in that the rigid external tube is selected in such a way that said external tube withstands an external pressure above 50 bars and in that the centering elements are placed in contact with the internal tube and the external tube so as to increase the mechanical resistance of the external tube to the external pressure.

10) A method as claimed in claim 9, wherein the centering elements are arranged around the internal tube, the internal tube provided with the centering elements is fed into the external tube and one of the two tubes is permanently deformed so as to bring the centering elements into contact with the internal tube and the external tube.

11) A method as claimed in claim 9, wherein the internal tube is fed into the external tube and a material is injected into the annular space so as to form centering elements in contact with the internal tube and the external tube.

12) A method as claimed in claim 9, wherein the centering elements are arranged around the internal tube, the internal tube provided with the centering elements is fed into the external tube and mechanical tightening of the centering elements against the internal tube and the external tube is performed.

13) A method as claimed in claim 9, wherein an insulating material having a thermal conductivity below 0.1 W.m⁻¹.K⁻¹ is arranged in the annular space.

14) A method as claimed in claim 9, wherein the annular space is placed under vacuum at a pressure below 0.1 bar abs.
